(19) United States
(12) Patent Application Publication
(10) Pub. No.: US 2025/0384782 A1
(43) Pub. Date: Dec. 18, 2025

(54) ARTIFICIAL INTELLIGENCE GAMIFIED LEARNING MANAGEMENT SYSTEM FOR FINANCIAL LITERACY AND MULTI-ASSET TRADING

(71) Applicant: Sanjay Pani, Port Washington, NY (US)

(72) Inventor: Sanjay Pani, Port Washington, NY (US)

(21) Appl. No.: 19/234,974

(22) Filed: Jun. 11, 2025

Related U.S. Application Data
(60) Provisional application No. 63/661,143, filed on Jun. 18, 2024.

(51) Int. Cl. G09B 5/02; G06N 20/00

(52) U.S. Cl. CPC G09B 5/02; G06N 20/00

(57) ABSTRACT

An artificial intelligence-powered gamified learning management system is disclosed, designed to enhance financial literacy and stock trading education. The system integrates adaptive learning, real-time market analytics, and interactive simulations, including a Fantasy Stock Trading League and Paper Trading Engine. The AI-powered Adaptive Learning Engine dynamically adjusts educational content and trade recommendations based on user performance, utilizing reinforcement learning and collaborative filtering models. The Market Insights Engine provides predictive analytics, sentiment analysis, and risk assessment using advanced AI models. Users engage in competitive trading simulations, sentiment-based challenges, and community-driven learning forums, fostering practical investment skills. The system offers personalized learning paths, real-time feedback, and post-trade analysis to improve decision-making. Principal uses include stock trading education, financial literacy enhancement, and gamified investment simulations. This system addresses the limitations of static financial education platforms by creating an interactive, adaptive, and engaging learning environment.

### CROSS-REFERENCE TO RELATED APPLICATIONS

This application claims benefit to Provisional Application No. 63/661,143, filed Jun. 18, 2024, the contents of which are herein incorporated by reference.

### BACKGROUND OF THE INVENTION

### Field of Endeavor

The present disclosure pertains to financial technology and educational systems, specifically to an AI-powered, gamified Learning Management System (LMS) designed to improve financial literacy and stock trading education through adaptive learning, real-time market analytics, and interactive simulations.

### Background of Related Art

This disclosure pertains to the field of financial technology and educational systems, particularly focusing on addressing the challenges associated with stock market education. Many sectors have undergone rapid technological advancements that have transformed traditional learning environments into dynamic, interactive experiences. However, in the area of financial literacy and investment education, conventional methods such as static lectures, paper-based exercises, and outdated simulations remain prevalent. These approaches often fail to sufficiently engage individuals who benefit from clear, practical, and adaptive learning experiences for complex subjects like trading. The overall environment reflects a growing demand for tools that incorporate modern digital techniques, including artificial intelligence and interactive methods, to foster a more accessible and effective learning atmosphere for potential investors.

A primary objective in this context is to provide an educational tool capable of bridging the gap between theory and real-world trading dynamics. Many educational platforms offer static content that does little to motivate users or foster long-term understanding of financial markets. There is significant potential for enhancing engagement by incorporating adaptive learning techniques that adjust to individual knowledge levels and trading experiences. A strong demand exists for a system that not only delivers educational content but actively responds to learner progress through real-time feedback, personalized content adjustments, and interactive simulations that mirror current market environments.

The broader problem centers on the persistent difficulty new investors face when entering the financial markets. The traditional educational methods available do not sufficiently account for the rapidly changing nature of these markets or the varying levels of expertise among learners. Many users find that existing tools fail to replicate the dynamic challenges of real-world trading, leaving them underprepared to manage risks and make informed investment decisions. In addition, conventional systems are often perceived as too theoretical and disconnected from the practical realities of market behavior, creating a barrier to developing confidence in trading skills.

More specifically, there is an acute need to address the shortcomings of conventional financial education platforms that rely on predetermined, inflexible course structures and basic simulation tools. These systems typically do not offer the interactive and personalized experiences necessary for learners to build real-world investment competence. The increasing complexity of financial markets demands a learning approach that can adjust to individual performance and provide insights based on current market conditions. A solution that integrates adaptive learning, real-time market analytics, and engaging, competitive elements can help overcome the limitations of static educational content, leading to a more holistic and effective financial learning experience.

### SUMMARY OF THE INVENTION

In one embodiment, the disclosure provides a computer-implemented system for delivering an artificial intelligence-powered, gamified learning management system for financial literacy and stock trading education. The system comprises an adaptive learning engine configured to dynamically adjust educational content based on user behavior and performance; a market insights engine that receives real-time or historical market data to generate insights; a fantasy stock trading league engine designed to simulate competitive trading contests by constructing user portfolios and ranking trades based on risk-adjusted returns and sentiment-backed evaluations; a paper trading engine that facilitates risk-free simulated trading via portfolio construction and trade execution using live market data or predictive forecasts; a community-driven sentiment-based trading engine that enables interactive learning through user discussions, sentiment-based trading challenges, and collaborative market research leveraging sentiment metrics derived from financial news and social media data; and a user interface module that presents educational content, simulated trading environments, real-time market analytics, and community interaction features. These components are integrated to automatically adjust personalized learning paths and simulated trading challenges in response to both individual user performance and prevailing market conditions.

In some embodiments, the adaptive learning engine employs artificial intelligence models selected from reinforcement learning and collaborative filtering, while the market insights engine may produce predictive analytics, sentiment analysis, or risk assessments. The fantasy stock trading league is also configured to dynamically update leaderboard rankings based on market insights outputs, and the market insights engine can output sentiment research metrics such as a Sentiment Momentum Index, a Sentiment Volume Ratio, a Sentiment Divergence Index, or a Social Sentiment Velocity. Additionally, the adaptive learning engine may include a natural language processing agent capable of responding to user queries related to financial news, economic trends, market sentiment, and investment research, and the user interface module may further offer gamified reward features that issue tokens or points according to user engagement and simulated trade activity, with scaling influenced by performance metrics.

### BRIEF DESCRIPTION OF THE DRAWINGS

FIG. 1A is a schematic block diagram illustrating the user interface workflow of the Rally Bulls platform, showcasing the primary functionalities and navigation structure of the platform;

FIG. 1B is a schematic block diagram illustrating the user interface workflow of the Rally Bulls platform, showcasing the primary functionalities and navigation structure of the platform;

FIG. 1C is a schematic block diagram illustrating the user interface workflow of the Rally Bulls platform, showcasing the primary functionalities and navigation structure of the platform;

FIG. 1D is a schematic block diagram illustrating the user interface workflow of the Rally Bulls platform, showcasing the primary functionalities and navigation structure of the platform;

FIG. 1E is a schematic block diagram illustrating the user interface workflow of the Rally Bulls platform, showcasing the primary functionalities and navigation structure of the platform;

FIG. 1F is a schematic block diagram illustrating the user interface workflow of the Rally Bulls platform, showcasing the primary functionalities and navigation structure of the platform;

FIG. 1G is a schematic block diagram illustrating the user interface workflow of the Rally Bulls platform, showcasing the primary functionalities and navigation structure of the platform;

FIG. 2A is a schematic flow chart diagram illustrating an AI-powered learning system and proprietary sentiment analysis for personalized financial education and market research;

FIG. 2B is a schematic flow chart diagram illustrating an AI-powered learning system and proprietary sentiment analysis for personalized financial education and market research;

FIG. 3A is a schematic flow chart diagram illustrating the AI-powered learning system and proprietary sentiment analysis for personalized financial education and investment research; and

FIG. 3B is a schematic flow chart diagram illustrating the AI-powered learning system and proprietary sentiment analysis for personalized financial education and investment research.

### DETAILED DESCRIPTION OF THE INVENTION

The present detailed description provides an overview of certain embodiments of the disclosed system, which pertains to an AI-powered, gamified financial learning system designed to enhance stock trading education and financial literacy. The disclosed system integrates advanced artificial intelligence (AI) models, gamification mechanics, and real-time market analytics to create an interactive and personalized learning experience. While specific examples and configurations are described herein, these are provided solely for illustrative purposes and are not intended to limit the scope of the disclosed system. The system described can be applied across various implementations, including stock trading education platforms, financial literacy tools, and gamified investment simulations.

The description aims to ensure clarity by potentially omitting or simplifying certain widely recognized elements, processes, and techniques to focus on the novel aspects of the disclosed subject matter. Additionally, the disclosed subject matter accommodates a wide range of potential modifications, rearrangements, and alternative configurations that align with the scope of the appended claims. For instance, the described modules, workflows, and AI-driven functionalities may be adapted, combined, or restructured to suit various use cases or technological environments without departing from the underlying principles of the disclosed subject matter.

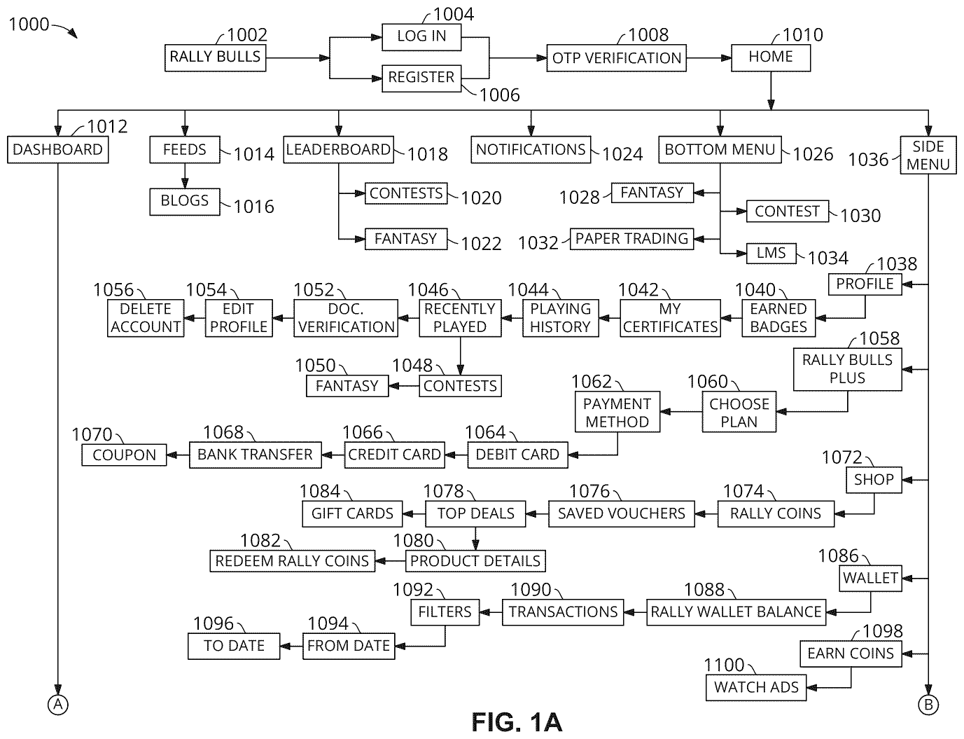

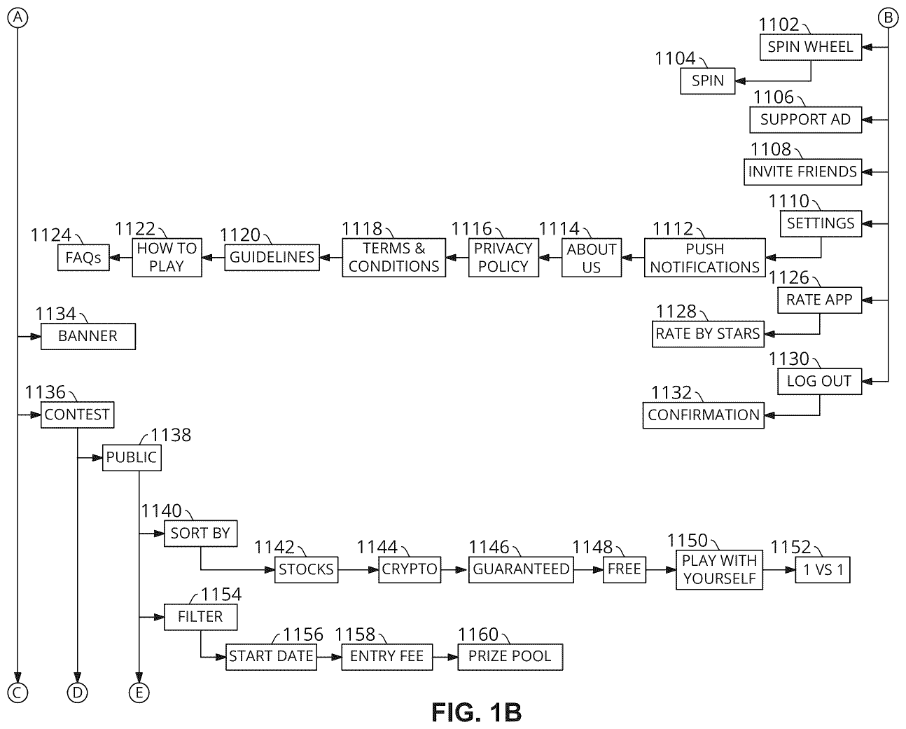

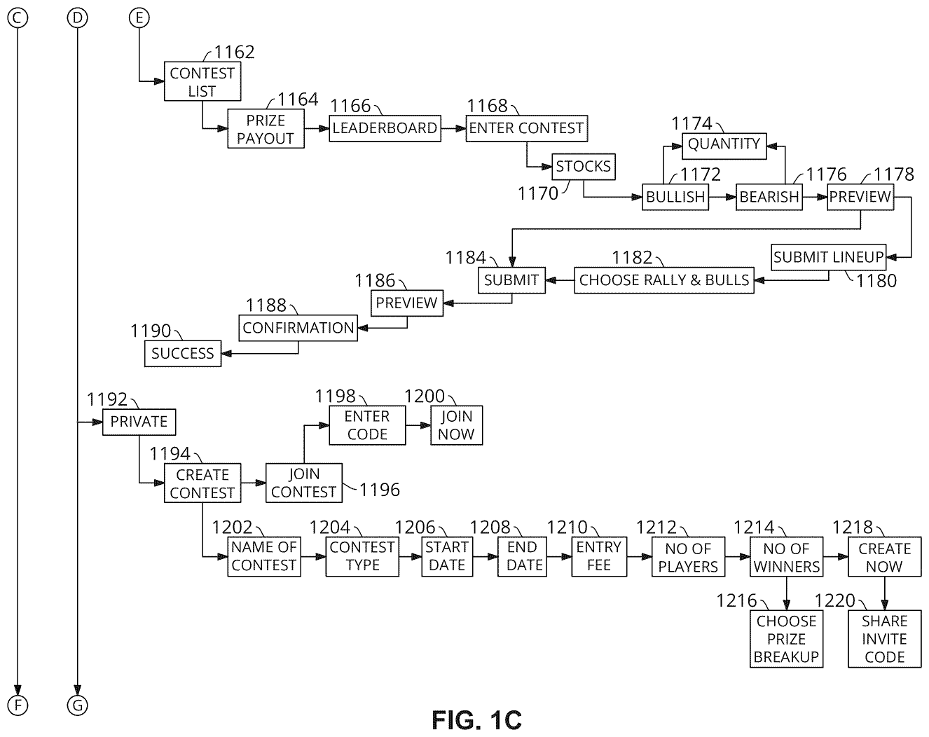

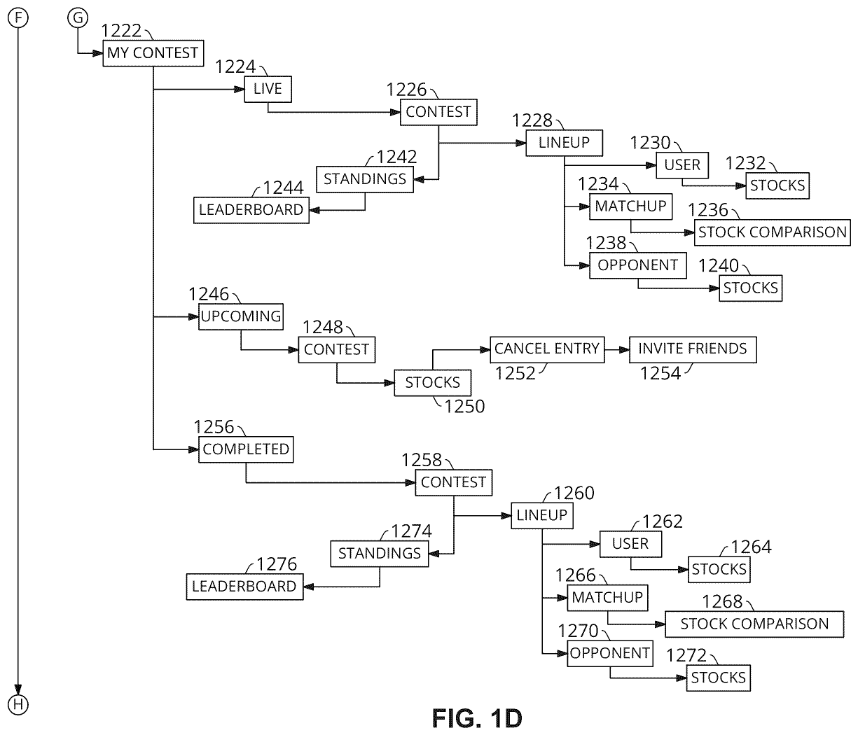

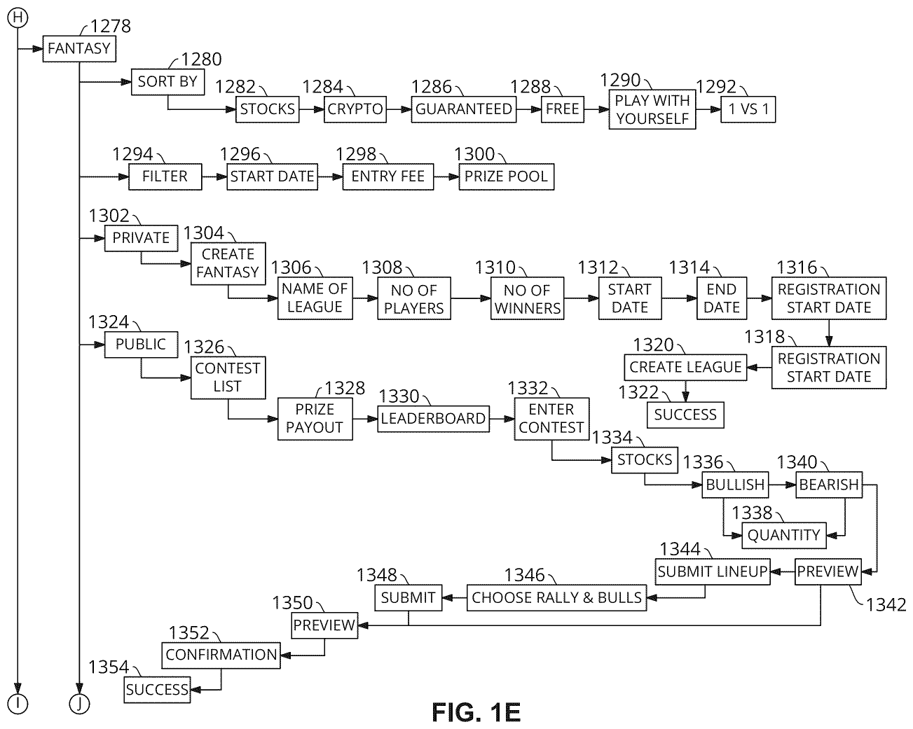

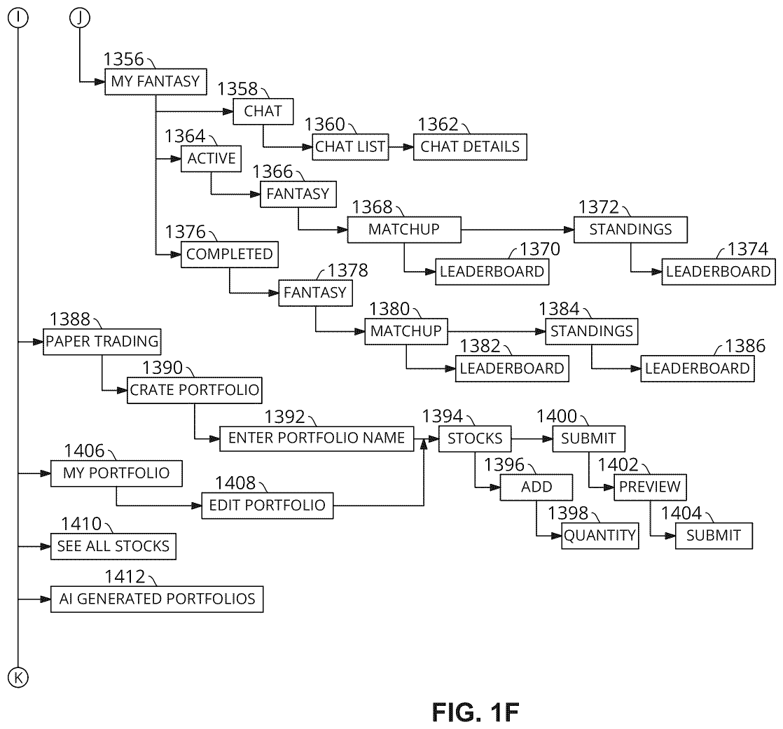

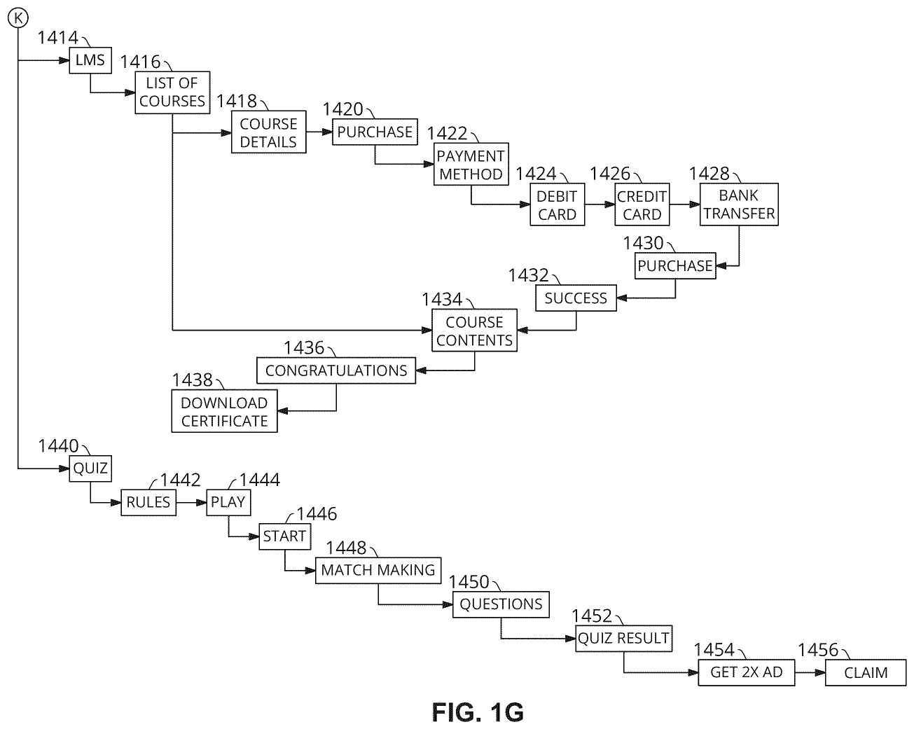

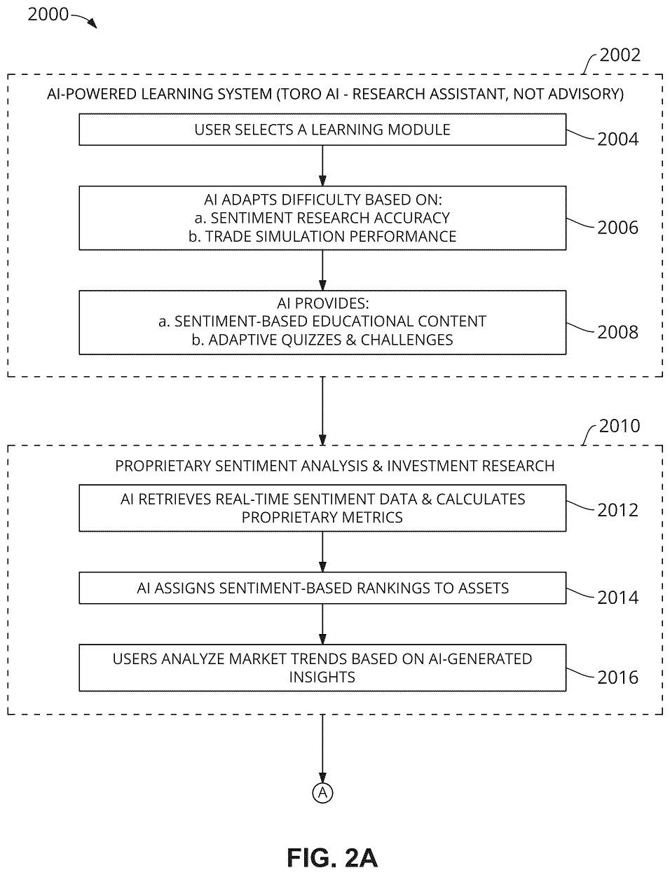

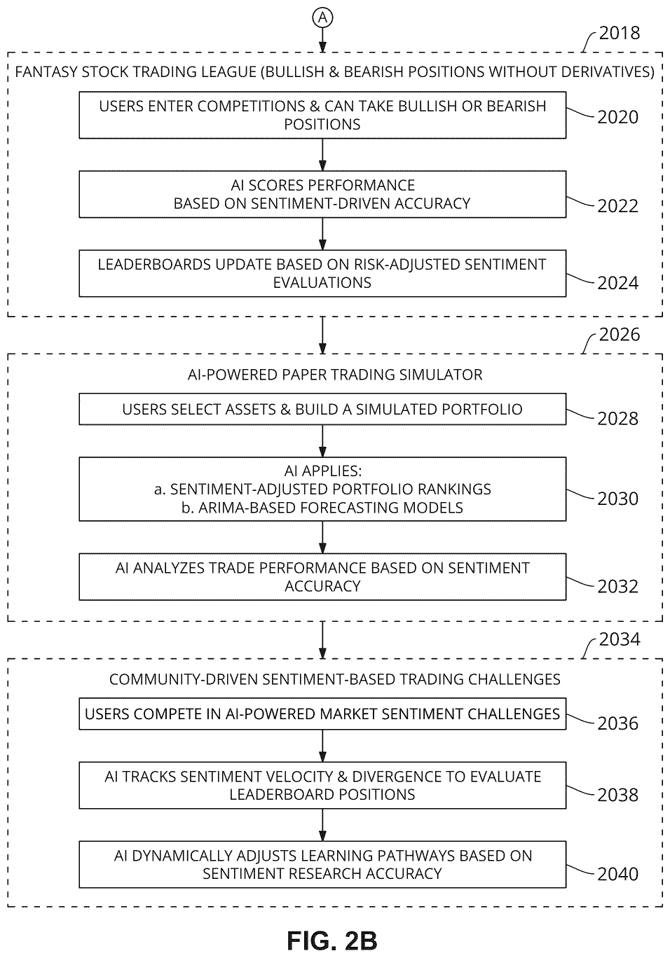

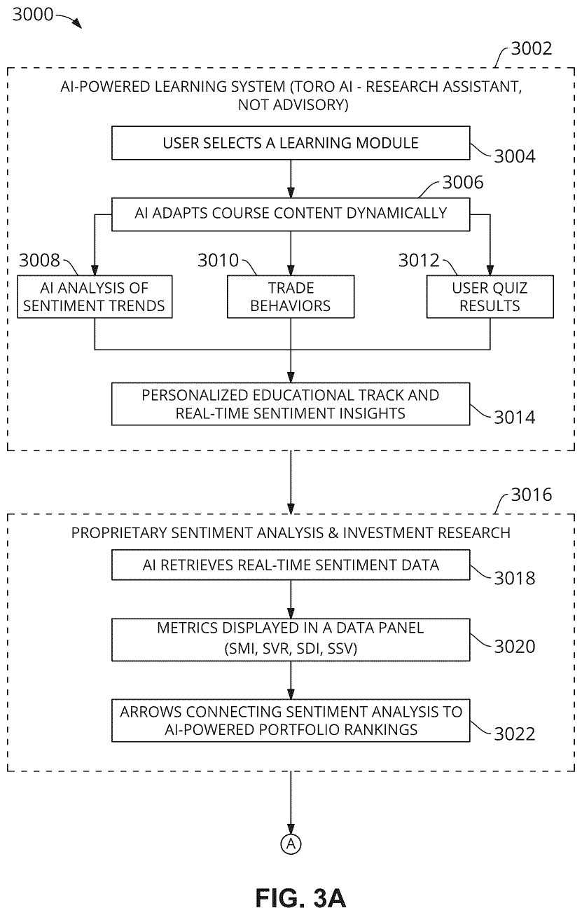

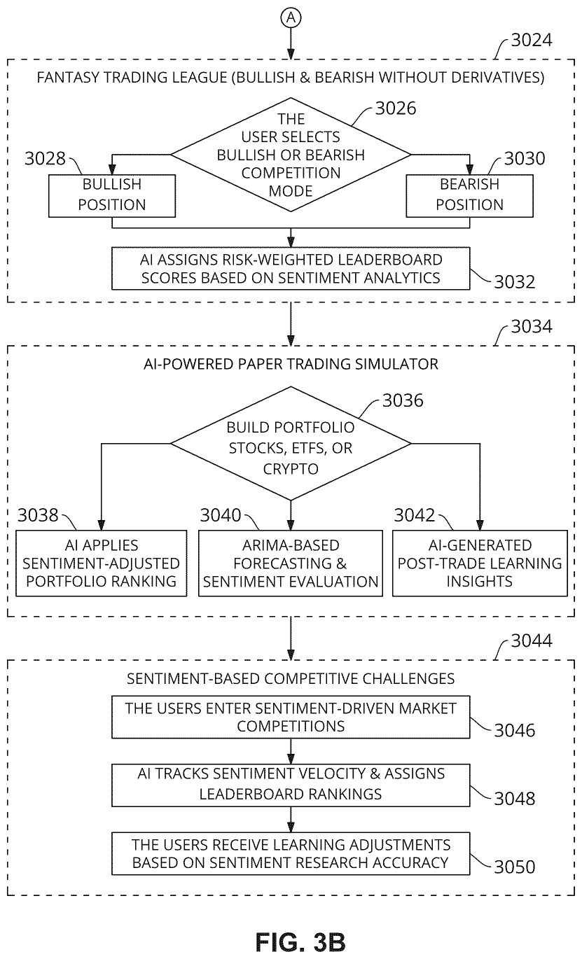

FIGS. 1-3 illustrate various aspects of the present invention and are useful for a complete understanding thereof. The System 2000/3000 of the present invention, hereinafter Rally Bulls System, is computer-based system having a plurality of modules, programs, applications, engines, etc., configured to provide one or more users one or more functionalities described hereinafter. The plurality of modules includes at least an AI-powered Adaptive Learning Engine 2002/3002, a Market Insights Engine 2010/3016, a Fantasy Stock Trading League Engine 2018/3024, a Paper Trading Engine 2026/3034/3034/3034, and/or a Community Driven Sentiment-Based Trading Engine 2034/3044/3044.

The AI-Powered Adaptive Learning Engine 2002 is configured to continuously and dynamically adjust difficulty levels of educational content, trade recommendations and risk assessments based on user behaviors and/or performance within the Rally Bulls System. In embodiments, the AI-Powered Adaptive Learning Engine 2002 utilizes one or more AI models to continuously and dynamically adjust difficulty levels of educational content, trade recommendations and risk assessments, such as a Reinforcement Learning Model, and/or a Collaborative filtering Model.

The Reinforcement Learning Model utilizes Q-learning based reinforcement learning to adapt content dynamically based on user interactions, i.e. past performance in System 2000. The Reinforcement Learning Model is configured to provide learning pathway customization by identifying areas of weakness, of a user, (e.g., understanding bearish signals, portfolio balancing) and adjusts content accordingly. For example, if a user struggles with risk management concepts, the system prioritizes those lessons until proficiency is achieved, or if a user demonstrates strong performance in portfolio balancing, the AI introduces more complex trading simulations. The Collaborative Filtering Model is configured to recommend educational content by comparing trading styles of one or more users and providing recommendations to users based on similarities in trading styles.

In embodiments, the one or more AI models utilize one or more input items in decision-making, such as User quiz performance, user engagement history, trade success rates & error patterns, user decisions in Fantasy Trading League Engine 2018/3034 and real stock simulations to improve financial decision-making skills, user trading behavior, outcomes from Paper Trading Engine 2026/3034, Fantasy Trading League Engine 2018/3034 outcomes, sentiment based market insights, etc. In response to the one or more inputs, Learning Engine 2002 performs one or more of: dynamic content recommendations such as Course recommendations and/or learning paths, which Adapts in real-time to each user's performance in one or more of: trading contests, quizzes, and paper trading simulations, adapts learning paths based on user engagement with financial content, simulated trades, and sentiment research accuracy; dynamic adjustment of learning difficulty, trade recommendations, and financial knowledge assessments based on user behavior; provides AI-generated insights on past trades, highlighting mistakes, risk areas, and learning opportunities; and/or provide new lessons or challenges based on the user's sentiment research accuracy.

In operation, a user can register with System 2000/3000, select their trading experience, such as: Beginner, Intermediate, Advanced, Expert, and learning preference(s), and can perform a short learning assessment. In response to the inputs, and the learning assessment Learning Engine 2002 can assign an initial literacy score. Based on the initial literacy score, Learning Engine 2002 dynamically recommends a learning path including one or more educational content items, and continuously updates the learning path, based on user behaviors/performance. In embodiments, upon completion of learning paths, and/or educational content the user can earn badges, certifications, and/or their financial literacy score can be updated.

Referring to an overall flow associated with AI-powered Adaptive Learning Engine 2002/3002. A user selects a learning module 2004/3004, Learning Engine 2002/3002 continuously and dynamically adjust difficulty levels of the learning module, based on one or more of: Sentiment Analysis 2006/3008, user behaviors and/or performance 2006/3010/3012, or other behaviors describe above, within the Rally Bulls System. As a result, AI-powered Adaptive Learning Engine 2002/3002 provides personalized education and real-time sentiment-based content 2008/3014, to a user.

The Market Insights Engine 2010/3016 is configured to provide real-time predictive analytics and other real-time data for use in System 2000/3000. In embodiments, Insights Engine 2010/3016 feeds real-time data, such as stock data and/or market sentiment data, to a Fantasy Stock Trading League Engine 2018/3024, a Paper Trading Engine 2026/3034 ensuring that all user decisions are influence by live and predictive market trends. In embodiments, Insights Engine 2010/3016 utilizes one or more AI models, such as a Predictive Stock Price Forecasting Model, a Sentiment Analysis and Market Trend Forecasting Model, and/or a Risk Assessment & Portfolio Optimization Model.

In embodiments, Predictive Stock Price Forecasting Model is configured to use historical stock data and/or pattern recognition to predict one or more of: short-term stock price movements, sector-based performance trends, and/or volatility fluctuations; and to provide event-driven trading alerts based on financial events, such as: earnings reports, interest rate hikes, company acquisitions, etc., and to send custom trade alerts to one or more users. In embodiments, one or more of historical stock pricing information, and/or real-time financial data provided Insight Engine 2010/3016 via one or more APIs, are fed to an Autoregressive Integrated Moving Average model configured to output short-term stock price movement forecasting, and one or more Long Short-Term Memory Networks configured to provide long-term trend prediction using historical stock data. Using the ARIMA and LTSM Insight Engine 2010/3016 outputs one or more probability-based trade recommendations for a user.

In embodiments, the Sentiment Analysis and Market Trend Forecasting Model is configured to output one or more market sentiment information items, such as Bullish vs. bearish sentiment trends, Stock-specific hype detection (e.g., short squeeze signals), Macroeconomic indicators affecting sector performance. In embodiments, the model receives financial data inputs, such as financial news sources (Bloomberg, Reuters, Yahoo Finance, etc.), social media data, such as Twitter, Reddit, and StockTwits social media discussions, and/or Earnings reports & economic indicators. In embodiments, the model utilizes one or more AI models, such as a Bidirectional Encoder Representation from Transformer (BERT) Natural Language Processing (NLP) Model, and/or one or more Random Forest Classifiers to output the one or more market sentiment information items. In embodiments, the BEST NLP Model Extracts market sentiment from financial news & social media. Additionally, the Random Forest Classifiers predict bullish/bearish sentiment based on social discussions & stock news volume. In embodiments, the Sentiment Analysis and Market Trend Forecasting Model calculates a plurality of metrics, such as a Sentiment Momentum Index which tracks how sentiment shifts impact rankings, a Sentiment Volume Ratio which quantifies ratio of positive v. negative mentions, a Sentiment Divergence Index, and/or a Social Sentiment Velocity, for use in determine a sentiment ranking.

In embodiments, the Sentiment Momentum Index (SMI) measures a change in sentiment over a specific time period, such that a rising SMI suggests bullish sentiment, while a falling SMI may indicate weakening sentiment. SMI is calculated by subtracting a previous sentiment score from a current sentiment score. In embodiments, sentiment scores are derived by scoring social media information to track real-time sentiment changes in markets.

In embodiments, Sentiment Volume Ratio (SVR) compares the ratio of positive to negative mentions on social media, such that a higher SVR signals bullish sentiment, while a lower SVR indicates bearish sentiment. SVR is calculated by dividing positive mentions on social media, which helps traders assess the strength of positive sentiment, by negative mentions on social media, which help traders gauge negative sentiment and potential downward pressure.

In embodiments, Sentiment Divergence Index (SDI) measures the divergence between positive and negative sentiment scores, such that a large SDI indicates a significant difference in sentiment, signaling strong market sentiment. SDI is calculated by taking positive sentiment scores derived from social media, which gauge the intensity of bullish sentiment, and subtracting negative sentiment scores derived from social media, which gauge the intensity of bearish sentiment.

In embodiments, Social Sentiment Velocity (SSV) measures how fast sentiment is changing over a given period, such that a fast change in sentiment suggests rapid market shifts, ideal for short-term trading strategies. SSV is calculated by dividing a change in sentiment score of a specified time period, which gauges the pace of sentiment change to anticipate quick market movements, by a Time interval.

In embodiments, Risk Assessment and Portfolio Optimization Model is configured to provide real-time risk assessment and/or trade optimizations, such as Highlight overexposed positions, Suggesting better sector allocation, Predicting potential downside risks, etc. In embodiments, the model receives one or more inputs, such as user trade history, portfolio composition, sectoral risk scores and/or historical asset performance. In embodiments, the one or more inputs are provided to one or more models, such as a Markowitz Modern Portfolio Theory (MPT) Model, and/or are subject to one or more simulations, such as Monte Carlo Simulations. In embodiments, the MPT Model optimizes one or more user portfolios for maximum return with minimum risk, utilizing the data provided, and the Monte Carlo Simulations are utilized to run thousands of portfolio scenarios to predict best and worst-case investment outcomes. Utilizing these models Insight Engine 2010/3016 AI evaluates each user's portfolio composition, providing real-time risk alerts & diversification suggestions.

In embodiments, Insight Engine 2010/3016 provides outputs to independently to one or more users, allowing the one or more users to access AI-powered trade insights without need to participate in a Fantasy Stock Trading League Engine 2018/3024, a Paper Trading Engine 2026/3034.

The Stock Trading League Engine 2018/3024 is configured to provide a competitive, AI-powered investment simulation where users: Build portfolios using Rally Coins (virtual currency); Compete against other users in AI-generated trading scenarios; Earn leaderboard rankings and rewards based on portfolio performance; and/or Receive AI-driven feedback on trade decisions, highlighting risk levels and profit potential. In embodiments, League Engine 2018/3024 receives data from Insights Engine 2010. Ensuring that users receive real-time AI-Drive feedback on trades, enabling the users to develop better strategies. In embodiments, a user can manage a portfolio consisting of stocks, exchange traded funds (ETF), cryptocurrencies, etc., which are scored dynamically by Insight Engine 2010/3016. In embodiments, scoring of the user's portfolio is based on one or more of: Trade profitability & consistency, Risk-adjusted returns, Sector-based diversification efficiency, Stock selection quality, Portfolio diversification & risk weighting, Sentiment-backed asset selection and/or Performance relative to Sentiment Momentum Index (SMI), Sentiment Volume Ratio (SVR), and Social Sentiment Velocity (SSV). In embodiments, the Insights Engine 2010/3016 utilizes its Risk Assessment and Portfolio Optimization Model to perform Monte Carlo simulations to analyze how a user's portfolio might perform under different market conditions and detects risky traded suggests adjustments before execution.

League Engine 2018/3024 provides one or more leaderboards and/or one or more Performance metrics. In embodiments, users are scored using AI-calculated risk-adjusted performance indicators, and the AI ensures that overleveraged or excessively risky trades receive lower rankings, teaching long-term portfolio resilience rather than just high-risk speculation. In embodiments, users can earn rewards, such as Rally Coins, based on the one or more performance metrics, which can be biased, such that higher risked-adjusted trade quality earns higher amounts of rewards. One or more additional customized games, or challenges, are provided by League Engine 2018/3024, such as Momentum Trading Contest, where users can Predict high-growth stocks based on AI trend detection; Risk Management Challenge where a user must optimize a portfolio under volatile market conditions; and/or Bear Market Survival Test where a user must adjust a fantasy portfolio during a simulated downturn.

In embodiments, the one or more customized games include: a Bullseye game, an over/under game, and/or a pick 3/4/5 game. In the Bullseye game a user(s) is presented with a future market scenario and must select the single asset they believe will most outperform over a set time frame. In the Over/Under game a user(s) predicts whether a selected asset will perform above or below a sentiment-weighted benchmark return. In the Pick 3/4/5, a user(s) chooses a mini-portfolio of 3, 4, or 5 assets expected to outperform a given index or peer set. Scoring is based on relative return, risk-adjusted accuracy, and alignment with key market indicators such as momentum, volatility, and analyst forecast bands.

In an exemplary application of League Engine 2018/3024, a user enters a competition 2020/3026 where they select either Bullish Trades (Long positions) 3028, or Bearish Trades (downside bets without derivatives) 3030. In some embodiments, users may declare a directional stance, such as bullish or bearish, prior to participating in a simulation or fantasy contest. This selection influences scoring logic based on whether the asset's subsequent performance aligns with the declared stance, adjusted for both quantitative indicators and market sentiment. These directional mechanics enable prediction-based gameplay with meaningful consequences, reinforcing hypothesis testing and user conviction modeling. The user makes one or more trades which are scored 2022, or ranked, by Insight Engine 2010/3016 based on one or more of: Portfolio diversification & risk weighting, Sentiment-backed asset selection, and/or Performance relative to Sentiment Momentum Index (SMI), Sentiment Volume Ratio (SVR), and Social Sentiment Velocity (SSV). After each trade, the leaderboard is updated in real-time based on Sentiment Scores 2024/3032 calculated by Insight Engine 2010/3016.

Additionally, in certain embodiments, the League Engine 2018/3024 may facilitate contests that involve simulated portfolio construction across multiple asset classes, including equities, exchange-traded funds (ETFs), and cryptocurrencies. These contests may use scoring frameworks based on portfolio performance, sentiment alignment, diversification efficiency, and risk-adjusted return. Asset selection may be guided by tools within the Investment Research Hub, such as P/E ratios, MACD, RSI, earnings yield, or sector rotation outlooks.

The Paper Trading Engine 2026/3034 is configured to allow a user to build a paper trading portfolio by selecting one or more assets 2028/3036. In embodiments, Simulator Engine 2026/3034 utilizes one or more data items Insights Engine 2010/3016 to create a risk-free market learning environment. In embodiments, a user builds one or more paper trading portfolios by selecting one or more assets, such as stocks, ETFs, cryptocurrency, etc., which are analyzed by Insights Engine 2010/3016. In embodiments, Insights Engine 2010/3016 performs one or more of the following: Generates model portfolios, incorporating sentiment analytics (SMI, SVR, SDI); Real-time ARIMA-based forecasting, helping users simulate price fluctuations; Livestock, ETF, and cryptocurrency market data for realistic portfolio construction; Dynamic AI Trade Review System, i.e. historical portfolio performance review against sentiment trends, identifying correlations and potential learning points; Suggests trade optimizations, risk assessments, and diversification strategies; and/or Trend predictions help users make informed trade decisions 2030/3038-3042. Trading Engine 2026/3034 allows users to receive AI-generated feedback on portfolio construction, risk exposure, and sentiment-trend accuracy, thereby improving learning 2032.

Community Driven Sentiment-based Trading Engine 2034/3044 is configured to provide one or more interactive learning tools driven by sentiment metrics. In embodiments, Trading Engine 2034/3044 provides one or more of: Community-Driven Learning allow users to engage in discussion forums, Discord networking, and collaborative research challenges, mentorship groups; and/or Sentiment-Based Trading Challenges allowing users compete to predict asset price movements based on proprietary sentiment scores 2036/3046. In embodiments, the sentiment metrics include, but are not limited to, Sentiment Momentum Tracking (SMI) which evaluates whether sentiment trends are accelerating or decelerating in real-time; and/or Social Sentiment Velocity (SSV) which measures how rapidly sentiment is shifting across trader discussions. In specific embodiments, one or more of the AI models of System 2000/3000 are utilized in Trading Engine 2034/3044 provide AI-powered discussion boards, trading forums, and mentorship groups, AI moderated community discussions to highlight relevant financial insights., and/or AI curated trading strategy recommendations based on peer-generated data.

While the present invention is described with reference to stock trading in various embodiments, the underlying features are applicable to trading or simulating portfolios across multiple asset classes, including stocks, exchange-traded funds (ETFs), and cryptocurrencies.

In further embodiments, the natural language processing-based agent (e.g., Toro AI) may provide real-time coaching during trading simulations or fantasy competitions. Coaching may be dynamically tailored based on: User actions or trade decisions, Shifts in market trends, Outputs from the Investment Research Hub, such as technical indicator triggers (MACD crossovers, RSI thresholds), sector news, or peer portfolio analysis. Feedback may include clarification of terms, presentation of relevant metrics (e.g., dividend yield, return on equity), and strategic questions that reinforce comprehension over prediction.

In an exemplary embodiment, a user enters a sentiment-based fantasy stock trading competition, through Trading Engine 2034/3044. Insight Engine 2010/3016 assigns sentiment-backed portfolio scoring based on accuracy of sentiment-driven trade decisions made by the user, and a leaderboard rankings update based on risk-adjusted, sentiment-weighted performance 2038/3048.

In another exemplary embodiment, Trading Engine 2034/3044 provides Real-Time Stock Market Simulations wherein users can paper trade using live stock data without financial risk. The Insight Engine 2010/3016 evaluates each user's trade strategy based on profitability, risk exposure, and long-term viability.

In another exemplary embodiment, Trading Engine 2034/3044 provides AI-Generated Trade Optimization & Diversification Suggestions wherein one or more AI models of the system provide real-time suggestions on risk-adjusted trade allocations, and/or offers alternative stock picks based on: Sector rotation models, Momentum trading signals, and/or Portfolio hedging strategies.

In another exemplary embodiment, Trading Engine 2034/3044 provides Post-Trade Analysis & Learning Module wherein one or more of the AI models of the system generate a detailed post-trade report after every transaction, showing: Trade efficiency ratings, Missed profit opportunities, and/or Risk assessment insights.

In another exemplary embodiment, Trading Engine 2034/3044 provides Sentiment research accuracy scores 2040/3050 to Learning Engine 2002/3002 wherein a user receives adjusted learning content and/or pathways based on sentiment research accuracy.

The system may also include a modular credentialing and assessment framework. This includes adaptive quizzes that assess knowledge of both fundamental and technical topics, including asset valuation, market psychology, portfolio construction, and sentiment interpretation. Based on performance, learners may earn badges or certifications linked to mastery tiers. Users who leverage the Research Hub to justify quiz responses or game decisions may receive additional recognition for applying data-driven reasoning to strategic choices.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a non-transitory machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include or be operatively coupled to receive data from or transfer data to, or both, one or more mass storage devices for storing data, e.g., magnetic, magneto optical disks, or optical disks. However, a computer need not have such devices. Generally, a computer will also include a communications device. The communication device can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wi-Fi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a Wi-Fi connection where data is passed through a Wi-Fi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination with a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together into a single software product or packaged into multiple software products.

It should be understood, of course, that the foregoing relates to exemplary embodiments of the invention and that modifications may be made without departing from the spirit and scope of the invention as set forth in the following claims.

What is claimed is:

1. A computer-implemented system for providing an artificial intelligence-powered, gamified learning management system for financial literacy and stock trading education, the system comprising:
an adaptive learning engine configured to dynamically adjust one or more educational content items based on one or more of a user behavior or a user performance;
a market insights engine configured to receive one or more of: real-time or historical market data, and to generate one or more insights;
a fantasy stock trading league engine configured to simulate competitive trading contests utilizing the one or more insights by constructing user portfolios, and to rank one or more trades based on metrics including risk-adjusted returns and sentiment-backed evaluations;
a paper trading engine configured to enable risk-free simulated trading by facilitating portfolio construction and trade execution using the one or more insights, live market data, or predictive market forecasts;
a community-driven sentiment-based trading engine configured to facilitate interactive learning through user discussions, sentiment-based trading challenges, and collaboration on market research by analyzing sentiment metrics derived from financial news and social media data; and
a user interface module configured to present educational content, simulated trading environments, real-time market analytics, and community interaction features to one or more users,
wherein the adaptive learning engine, market insights engine, fantasy stock trading league engine, paper trading engine, and community-driven sentiment-based trading engine are integrated to automatically adjust personalized learning paths and simulated trading challenges responsive to at least one of individual user performance and prevailing market conditions.

2. The computer-implemented system of claim 1, wherein the adaptive learning engine employs one or more artificial intelligence models selected from reinforcement learning and collaborative filtering.

3. The computer-implemented system of claim 1, wherein the one or more insights are one or more of: of: one or more predictive analytics, one or more sentiment analysis, or one or more risk assessments.

4. The computer-implemented system of claim 1, wherein the fantasy stock league is further configured to: update at least one leaderboard rankings dynamically based on outputs from the market insights engine.

5. The computer-implemented system of claim 1, wherein the market insights engine is further configured to output sentiment research metrics selected from a group consisting of: a Sentiment Momentum Index (SMI), a Sentiment Volume Ratio (SVR), a Sentiment Divergence Index (SDI), and a Social Sentiment Velocity (SSV).

6. The computer-implemented system of claim 1, wherein the adaptive learning engine further comprises a natural language processing-based agent configured to respond to user queries related to financial news, economic trends, market sentiment, and investment research.

7. The computer-implemented system of claim 1, wherein the user interface module is further configured to provide gamified reward features, including issuance of tokens or points based on user engagement and simulated trade activity, with scaling influenced by performance metrics.

8. The computer-implemented system of claim 1, wherein the fantasy stock trading league engine further enables users to participate in scenario-based strategic games, including Bullseye, Over/Under, and Pick 3/4/5, designed to assess forecasting accuracy, probability judgment, and sector selection skill.

9. The computer-implemented system of claim 1, wherein the fantasy trading league engine is further configured to enable users to declare a directional stance of either bullish or bearish during simulated contests, with outcomes scored based on sentiment-backed forecasting and comparative market performance.

10. The computer-implemented system of claim 1, wherein the fantasy trading league engine is further configured to facilitate simulated portfolio contests across multiple asset classes, including equities, exchange-traded funds (ETFs), and cryptocurrencies, with scoring determined by sentiment-weighted, risk-adjusted portfolio performance.

11. The computer-implemented system of claim 1, wherein the natural language processing-based agent is further configured to provide real-time contextual coaching during fantasy trading or paper trading challenges, based on user decisions and outputs from the market insights engine.

12. The computer-implemented system of claim 1, wherein the user interface module further integrates adaptive quizzes and certification pathways, issuing digital badges and achievement credentials based on demonstrated proficiency in financial literacy topics and simulated trading performance.
